(19) United States
(12) Patent Application Publication
(10) Pub. No.: US 2019/0299223 A1
(43) Pub. Date: Oct. 3, 2019

(54) WATER SPRAY GUN

(71) Applicant: AQUALEAN MANUFACTURING ASSOCIATES CO., LTD., Taipei City (TW)

(72) Inventor: Pin-Hsien YU, Taipei City (TW)

(21) Appl. No.: 15/943,128

(22) Filed: Apr. 2, 2018

(51) Int. Cl. B05B 1/16; B05B 9/01

(52) U.S. Cl. CPC B05B 1/1636; B05B 9/01

(57) ABSTRACT

A water spray gun has a grip with an inlet passage, a branching structure connected to the top portion of the grip, and an outlet structure connected to the branching structure. The outlet structure is internally formed with a plurality of outlet passages each corresponding to a different setting of the water outlet mode of the outlet structure. The branching structure has a transverse through-hole to be interconnected to the inlet passage and the plurality of outlet passages; a controlling component fitted inside the through-hole in a rotary mode and being provided to seal the opposite ends of the through-hole; and a triggering piece connected to the controlling component and provided to drive the controlling component to rotate in relation to the inner wall of the through-hole, so as to introduce the water delivered into the grip from the inlet passage into a corresponding outlet passage inside the outlet structure.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

### 1. Field of the Invention

The present invention relates generally to a water spray gun, and more particularly to an innovative one which facilitates single-handed operation for changing the water outlet mode.

### 2. Description of Related Art Including Information Disclosed Under 37 CFR 1.97 and 37 CFR 1.98

Although the conventional water spray guns offer the function to select multiple water outlet modes, some improvements need to be made for easier operation. When changing the water outlet mode of a conventional water spray gun, the user must use one hand to grip the main body of the water spray gun, and use the other hand to hold the water spray head, and then turn the water spray head in relation to the gun body. As single-hand operation is impossible, the user will usually stop the water spray temporarily to change the water outlet mode, so as to avoid unexpected water spray during the change.

### BRIEF SUMMARY OF THE INVENTION

The main objective of the present invention is to provide an ideally practical water spray gun, which offers an innovative breakthrough to solve the above-mentioned problem, and which features a structural design to enable single-hand operation to change the water outlet mode.

The technical feature of the present invention to solve the above-mentioned problem mainly lies in that, the water spray gun comprises a grip with an inlet passage formed internally, a branching structure connected to the top portion of the grip, and an outlet structure connected to the branching structure. The outlet structure is internally formed with a plurality of outlet passages, distributed serially from top to bottom, wherein, each outlet passage corresponds to a different setting of the water outlet mode of the outlet structure. The branching structure comprises a transverse through-hole, said through-hole being respectively connected to the inlet passage and the plurality of outlet passages. A controlling component is fitted inside the through-hole in a rotary manner, said controlling component sealing the opposite ends of the through-hole in a liquid-tight manner, said controlling component being formed with a water outlet and the plurality of outlet passages being distributed serially along the moving path of the water outlet. The controlling component selectively seals the inlet passage, and when the controlling component opens the inlet passage, the water outlet is interconnected with a corresponding outlet passage. A triggering piece is connected to the controlling component, said triggering piece being provided to drive the controlling component to turn in relation to the inner wall of the through-hole, so that, when the controlling component opens the inlet passage, the water from the inlet passage can be introduced into a corresponding outlet passage inside the outlet structure.

### BRIEF DESCRIPTION OF THE SEVERAL VIEWS OF THE DRAWINGS

FIG. 1 is a perspective view of the present invention.

FIG. 2 is an exploded perspective view of the present invention.

FIG. 3 is a partial perspective view of the present invention showing the outlet structure.

FIG. 4 is an exploded view of the controlling component of the present invention.

FIG. 5 is another partial perspective view of the present invention showing the outlet structure.

FIG. 6 is a testing view of the present invention.

FIG. 7 is a partial sectional view of the present invention.

FIG. 8 is a first operating view of the present invention.

FIG. 9 is a second operating view of the present invention.

FIG. 10 is a third operating view of the present invention.

FIG. 11 is a partial exploded view of a second preferred embodiment of the present invention.

FIG. 12 is a partial sectional view of a second preferred embodiment of the present invention.

FIG. 13 is a first operating view of a second preferred embodiment of the present invention.

FIG. 14 is a second operating view of a second preferred embodiment of the present invention.

FIG. 15 is a third operating view of a second preferred embodiment of the present invention.

FIG. 16 is an exploded sectional view of a third preferred embodiment of the present invention.

### DETAILED DESCRIPTION OF THE INVENTION

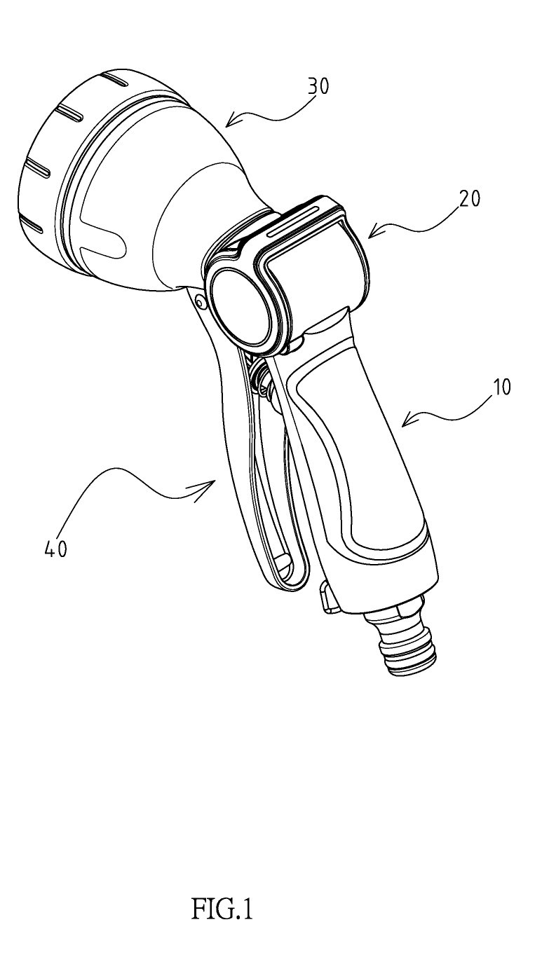

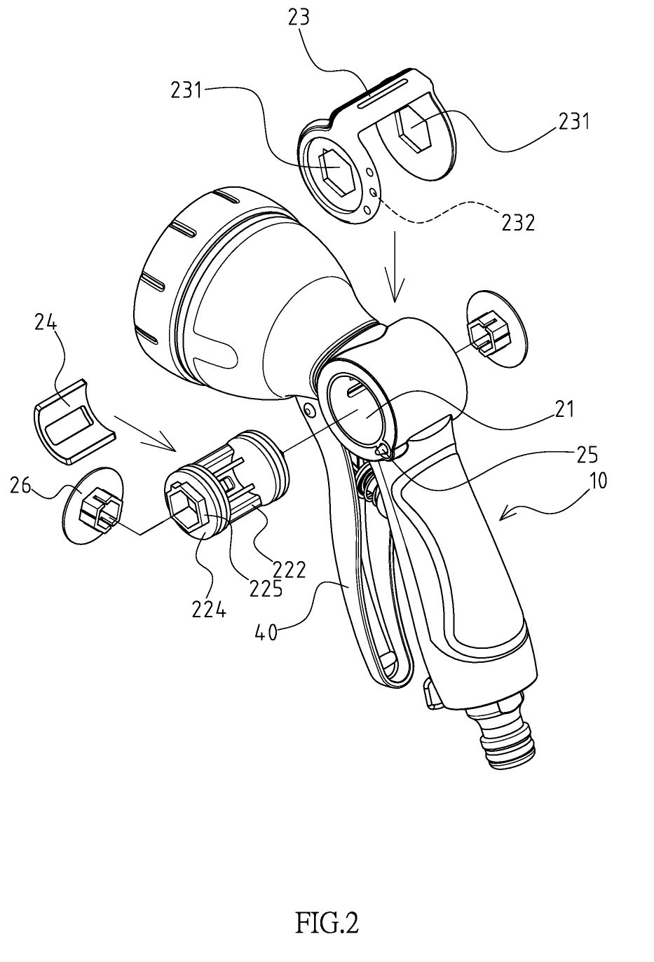

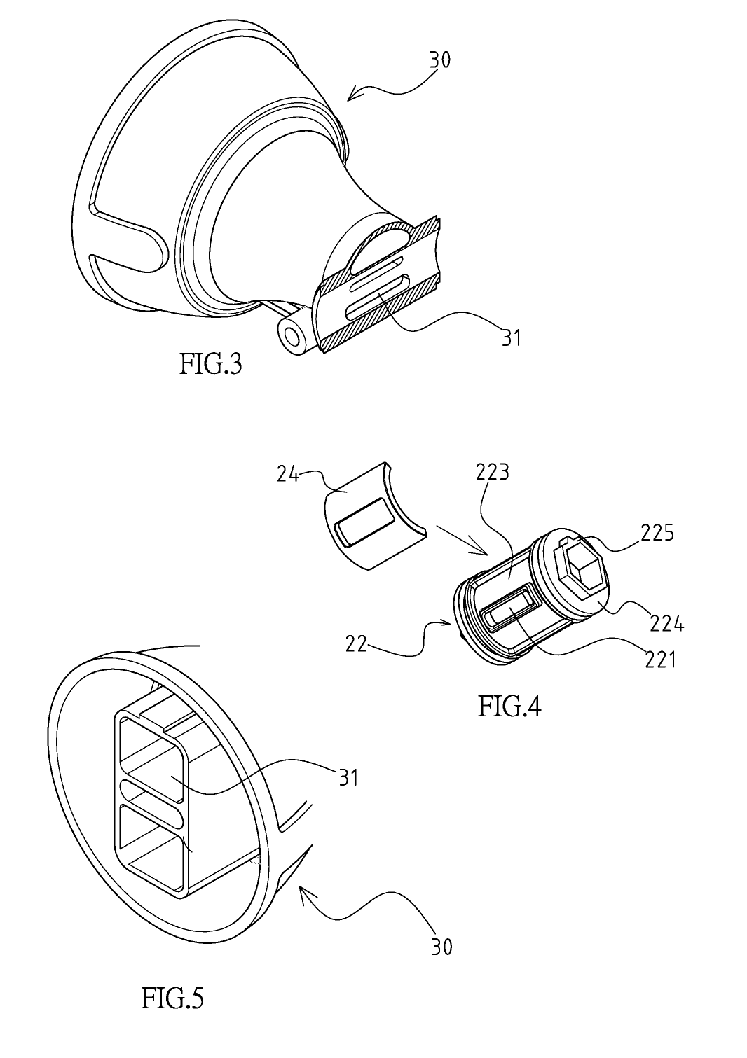

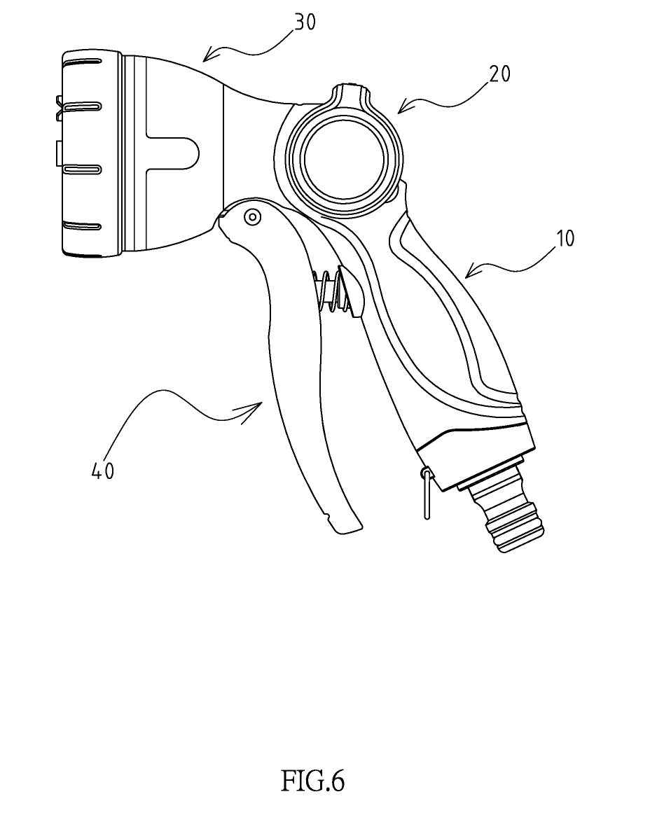

FIGS. 1-7 are illustrations of a preferred embodiment of the water spray gun disclosed in the present invention. However, such an embodiment is for the purpose of illustration only, and is not intending to limit the scope of patent. Said water spray gun comprises a grip 10 with an inlet passage 11 formed internally, a branching structure 20 connected to the top portion of the grip 10, an outlet structure 30 connected to the branching structure 20, and a trigger structure 40 connected to said outlet structure 30 and said grip 10. Said trigger structure 40 selectively opens the inlet passage 11 inside the grip 10, so that the water can flow serially through the branching structure 20 and the outlet structure 30 and then be sprayed outside. The outlet structure 30 is internally formed with a plurality of outlet passages 31 distributed serially from top to bottom, wherein, each outlet passage 31 corresponds to a different setting of the water outlet mode of the outlet structure 30. Said branching structure 20 comprises a transverse through-hole 21, said through-hole 21 being respectively connected to the inlet passage 11 and the plurality of outlet passages 31; a controlling component 22 fitted inside the through-hole 21 in a rotary manner, said controlling component 22 sealing the opposite ends of the through-hole 21 in a liquid-tight manner, said controlling component 22 being formed with a water outlet 221, and the plurality of outlet passages 31 being distributed serially along the moving path of the water outlet 221; and a triggering piece 23 connected to the controlling component 22, said triggering piece 23 being provided to drive the controlling component 22 to turn in relation to the inner wall of the through-hole 21, so that, when the trigger structure 40 opens the inlet passage 11, the water from the inlet passage 11 can be introduced into a corresponding outlet passages 31 inside the outlet structure 30.

Said controlling component 22 comprises a curved plate 222, and said water outlet 221 is formed on the curved plate 222; the side of the curved plate 222 facing the inner wall of the through-hole 21 is formed with a groove 223 surrounding the water outlet 221 and inside the groove 223, a waterproof gasket 24 is fitted. Said waterproof gasket 24 is attached to the inner wall of the through-hole 21 in a liquid-tight manner. The two ends of the curved plate 222 are respectively configured with a round disc 224, and the outer wall of each round disc 224 is configured with a polygonal stopping block 225; the triggering piece 23 has two sides respectively formed with a polygonal hole 231, wherein, each polygonal hole 231 traps a corresponding polygonal stopping block 225.

One side of the branching structure 20 is installed with a shoring piece 25, said shoring piece 25 capable of reciprocating and axial movement in relation to the branching structure 20. The side of the controlling component 22 facing the shoring piece 25 is fitted with a covering plate 26. Furthermore, the inner side of the triggering piece 23 corresponding to the shoring piece 25 is formed with a plurality of stopping holes 232, and the number of such stopping holes 232 is in an arrangement to correspond to that of the outlet passages 31. When the water outlet 221 is interconnected to a corresponding outlet passage 31, the free end portion of the shoring piece 25 is locked inside a corresponding stopping hole 232, so that the controlling component 22 is temporarily positioned in relation to the branching structure 20.

Based on the above-mentioned structural constitution, the operation of the present invention is as follows: in the preferred embodiment, the number of outlet passages 31 is configured to be three, and, for easy explanation of the operation of the present invention, such outlet passages 31 are further defined as first outlet passage 31A, second outlet passage 31B and third outlet passage 31C serially from top to bottom. In the preferred embodiment of the present invention, the opening and closing of the inlet passage 11 is controlled by the trigger 40. Therefore, the controlling component 22 has three operating positions (including: first water outlet position, second water outlet position and third water outlet position).

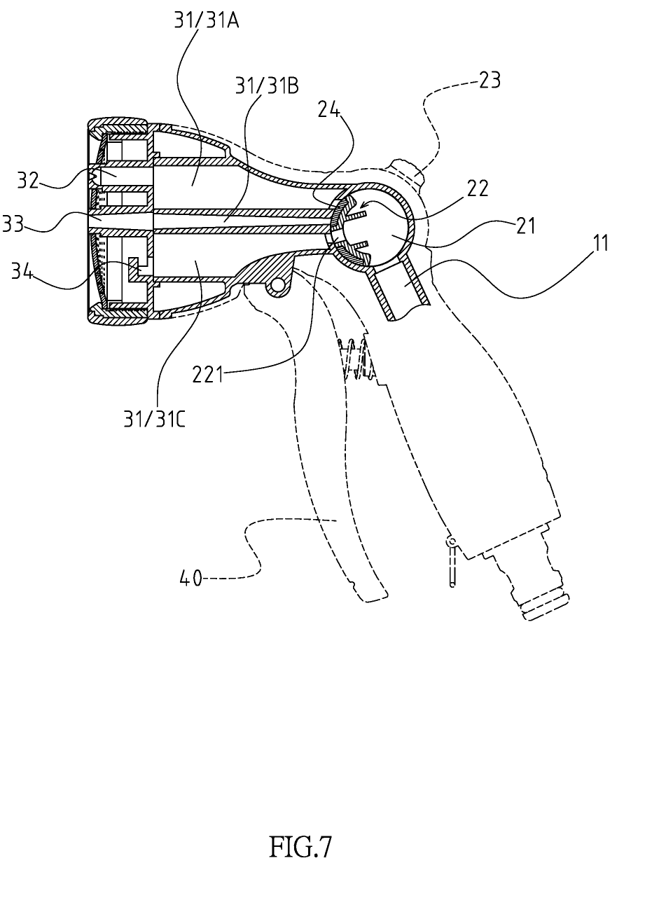

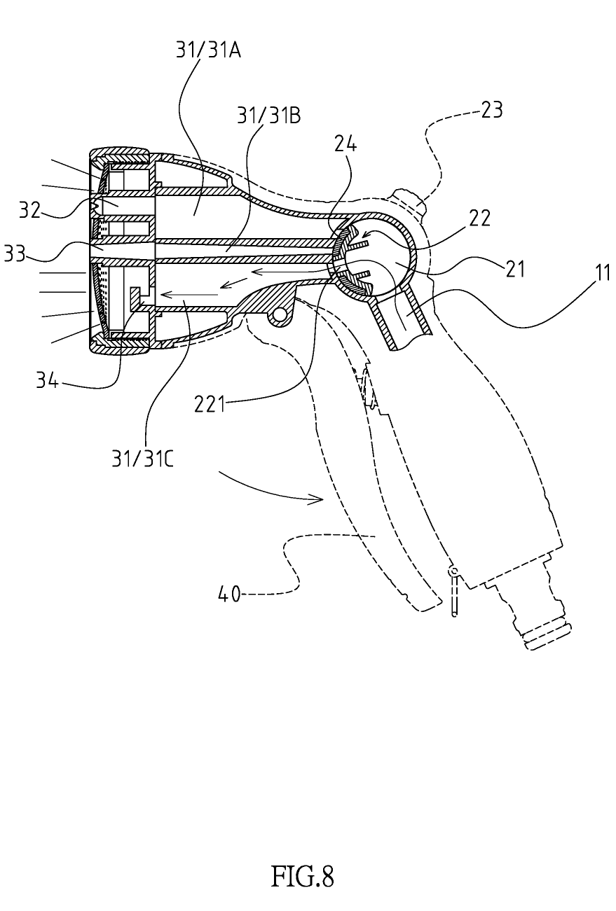

When the controlling component 22 is located at the first water outlet position, as shown in FIGS. 7 and 8, the first outlet passage 31A and second outlet passage 31B are closed by the waterproof gaskets 24; the inlet passage 11 is interconnected to the through-hole 21, and the two ends of the water outlet 221 are respectively connected to the third outlet passage 31C and the through-hole 21. Thus, when the user presses the trigger structure 40 to open the inlet passage 11, the high-pressure water from outside pipe will go through the inlet passage 11, the through-hole 21, the water outlet 221 and the third outlet passage 31C, and be sprayed out from the shower outlet module 34 configured on the front end of the outlet structure 30.

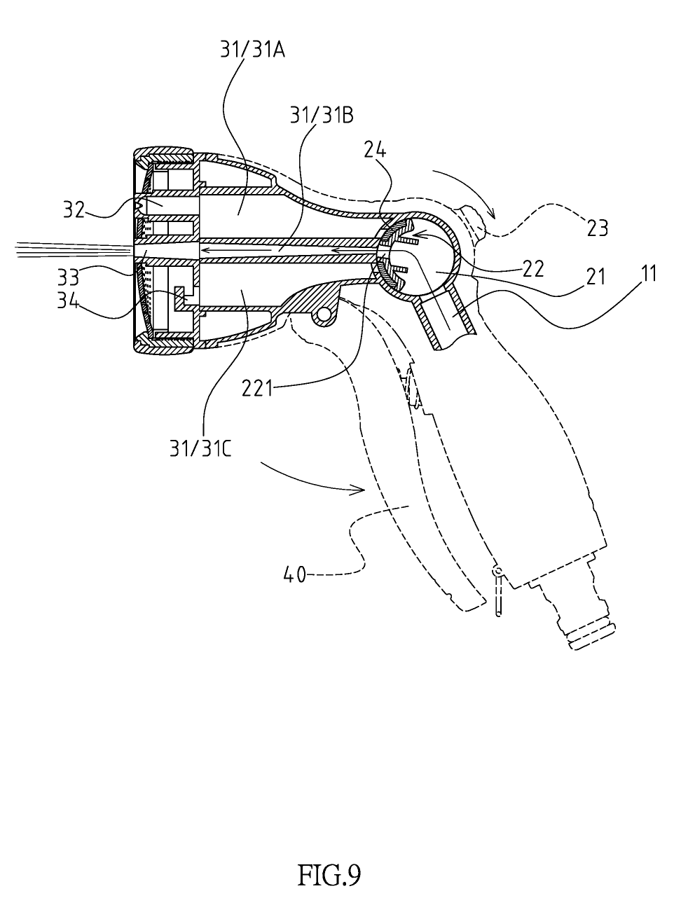

Referring to FIG. 9, when the user wants to change the water outlet mode of the outlet structure 30, he can just use the thumb of his hand holding the grip 10 to pull the triggering piece 23 backward, so as to turn the controlling component 22 simultaneously in the same direction in relation to the inner wall of the through-hole 21, and the controlling component 22 will rotate to its second water outlet position. Now, the first outlet passage 31A and third outlet passage 31C are respectively closed by the waterproof gaskets 24, the inlet passage 11 is interconnected to the through-hole 21, and the two ends of the water outlet 221 are respectively connected to the second outlet passage 31B and the through-hole 21. Thus, when the user presses the trigger structure 40 to open the inlet passage 11, the high-pressure water from the outside pipe will go through the inlet passage 11, the through-hole 21, the water outlet 221 and the second outlet passage 31B, and be sprayed out from the jet outlet module 33 configured on the front end of the outlet structure 30.

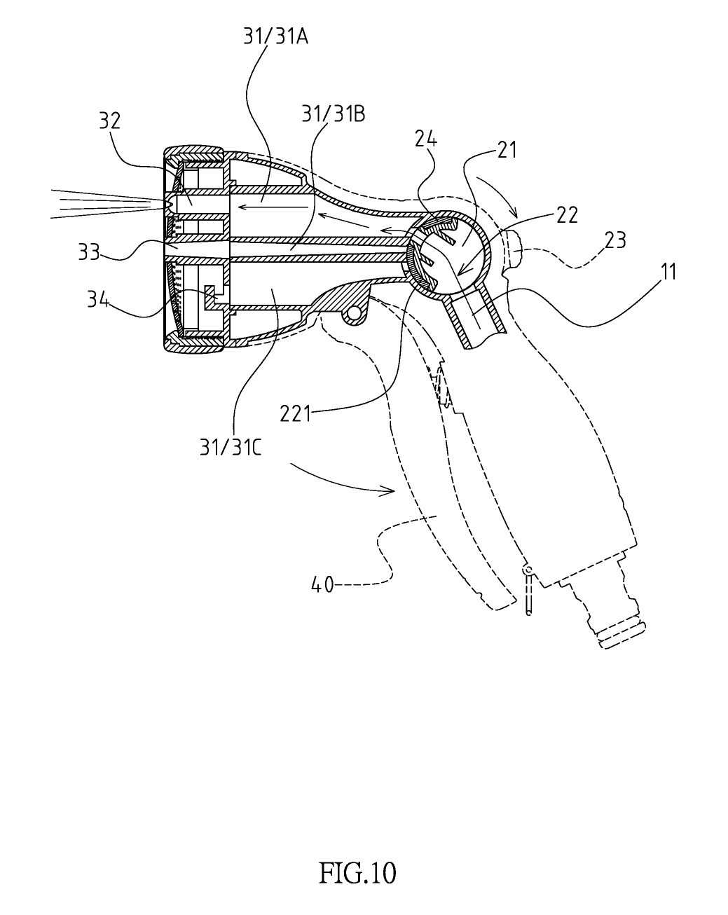

Referring to FIG. 10, when the user wants to further change the water outlet mode of the outlet structure 30, he can just use the thumb of the his hand holding the grip 10 to pull the triggering piece 23 further backward, so as to turn the controlling component 22 simultaneously and in the same direction in relation to the inner wall of the through-hole 21, and the controlling component 22 will rotate to the third water outlet position. Now, the second outlet passage 31B and third outlet passage 31C are respectively closed by the waterproof gaskets 24, the inlet passage 11 is interconnected to the through-hole 21, and the two ends of the water outlet 221 are respectively connected to the first outlet passage 31A and the through-hole 21. Thus, when the user presses the trigger structure 40 to open the inlet passage 11, the high-pressure water from the outside pipe will go through the inlet passage 11, through-hole 21, the water outlet 221 and the first outlet passage 31A, and be sprayed out from the flat outlet module 32 configured on the front end of the outlet structure 30.

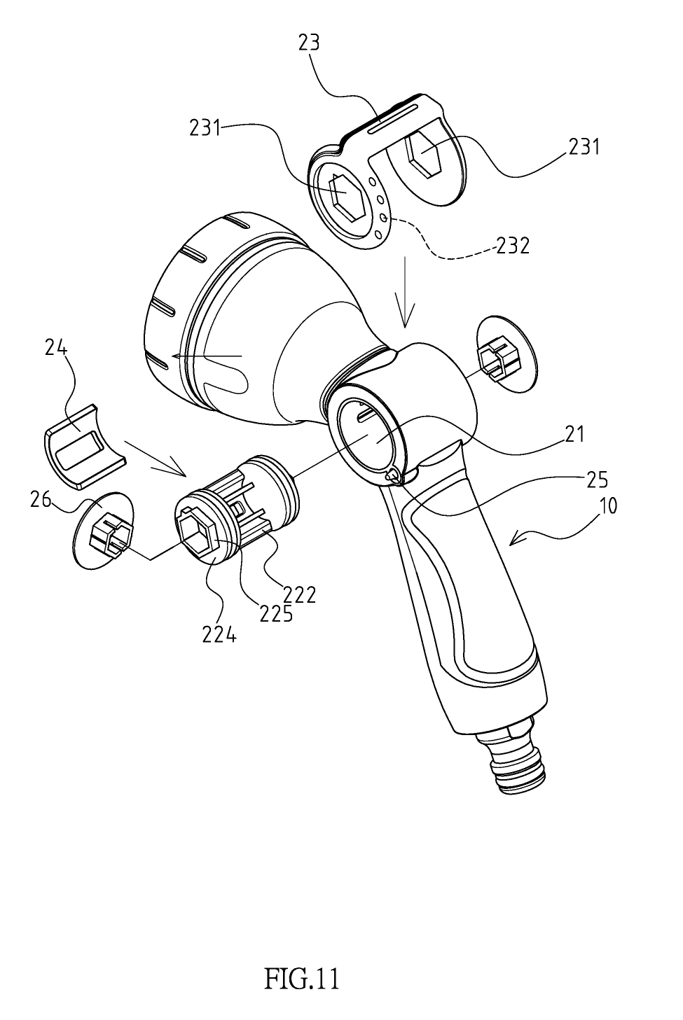

Referring to FIG. 11, a second preferred embodiment of the present invention is illustrated. The structure and operation of this preferred embodiment are almost the same as the above-stated first preferred embodiment, but there is no configuration of a trigger structure 40, and the controlling component 22 is configured with 4 operating positions (including: stopping position, first water outlet position, second water outlet position and third water outlet position). And, the number of stopping holes 232 are also configured to be four to correspond with the number of operating positions of the controlling component 22. When the controlling component 22 is located on a corresponding position, the free end portion of the shoring piece 25 is locked inside the corresponding stopping hole 232, so as to position the controlling component 22 temporarily in relation to the branching structure 20.

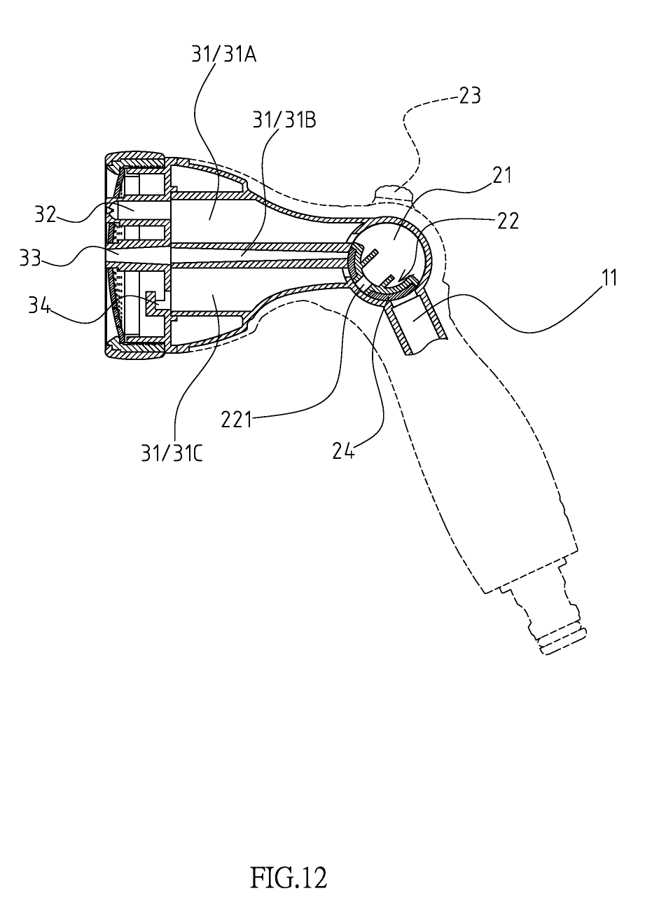

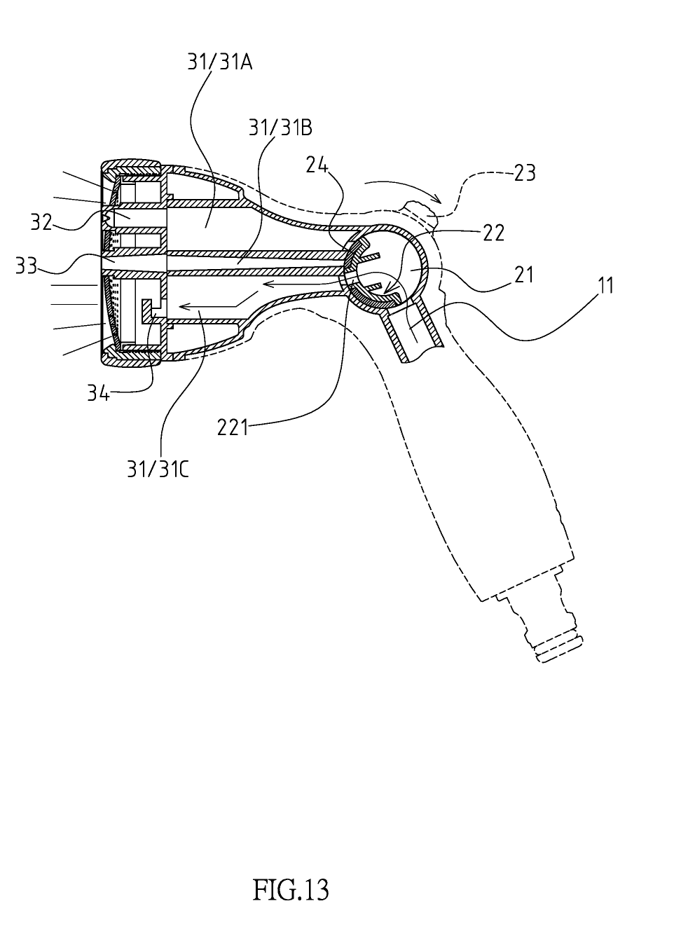

Referring to FIG. 12, a sectional view is provided to show the location of the controlling component 22 at its stopping position. When the controlling component 22 is at the stopping position, the inlet passage 11 is closed directly by the waterproof gasket 24, and thus no water will come into the outlet structure 30, and the present invention is at the stop-water state. Referring to FIG. 13, a sectional view is provided to show the location of the controlling component 22 at its first water outlet position. When the controlling component 22 is at the first water outlet position, the first outlet passage 31A and second outlet passage 31B are closed by the waterproof gaskets 24; the inlet passage 11 is interconnected to the through-hole 21, the two ends of the water outlet 221 are respectively connected to the third outlet passage 31C and the through-hole 21. Thus, the high-pressure water from the outside pipe will go through the inlet passage 11, the through-hole 21, the water outlet 221, and the third outlet passage 31C, and sprayed out from the shower outlet module 34 configured on the front end of the outlet structure 30.

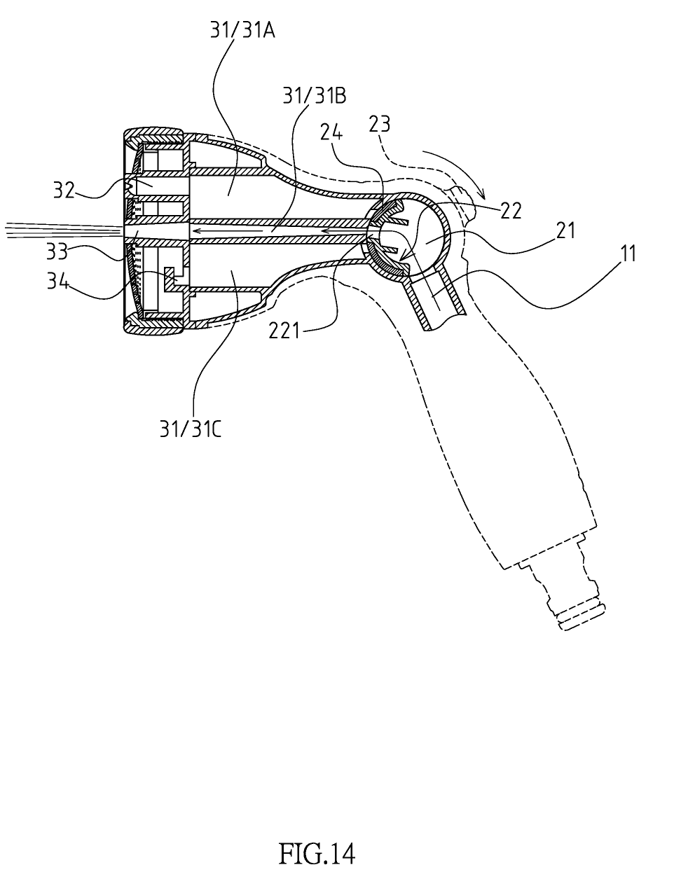

Referring to FIG. 14, when the user wants to further change the water outlet mode of the outlet structure 30, he can just use the thumb of his hand hold the grip 10 to pull the triggering piece 23 backward, to turn the controlling component 22 simultaneously and in the same direction in relation to the inner wall of the through-hole 21, and the controlling component 22 will rotate to its second water outlet position. Now, the first outlet passage 31A and the third outlet passage 31C are respectively closed by the waterproof gaskets 24, the inlet passage 11 is interconnected to the through-hole 21, and the two ends of the water outlet 221 are respectively connected to the second outlet passage 31B and the through-hole 21. Thus, the high-pressure water from the outside pipe will go through the inlet passage 11, the through-hole 21, the water outlet 221, and the second outlet passage 31B, and be sprayed out from the jet outlet module 33 configured on the front end of the outlet structure 30.

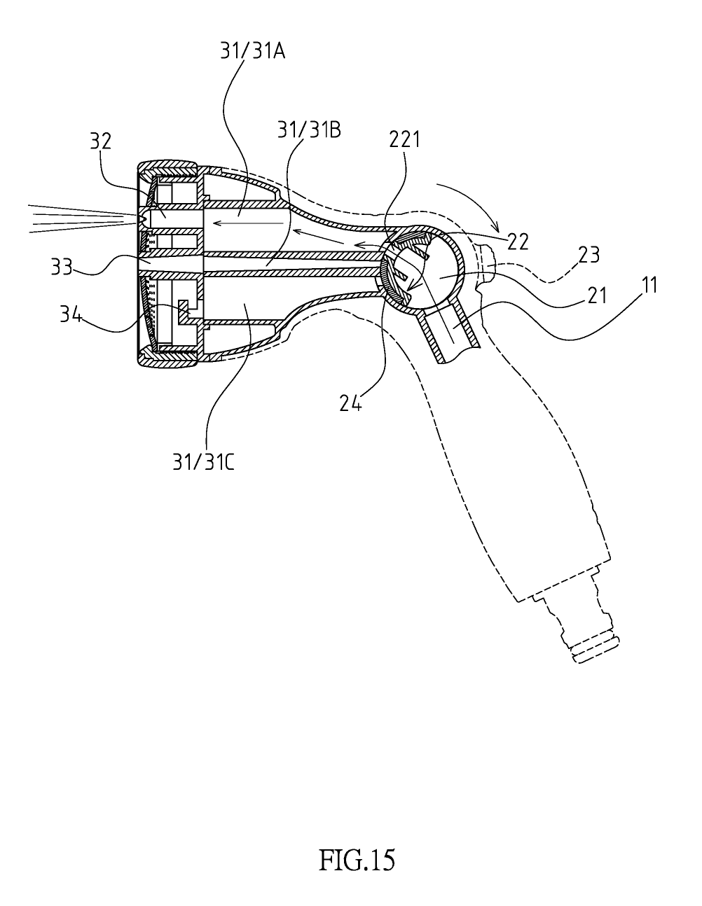

Referring to FIG. 15, when the user wants to further change the water outlet mode of the outlet structure 30, he can just use the thumb of his hand holding the grip 10 to pull the triggering piece 23 further backward, to turn the controlling component 22 simultaneously and in the same direction in relation to the inner wall of the through-hole 21, and the controlling component 22 will rotate to its third water outlet position. Now, the second outlet passage 31B and the third outlet passage 31C are respectively closed by the waterproof gaskets 24, the inlet passage 11 is interconnected to the through-hole 21, and the two ends of the water outlet 221 are respectively connected to the first outlet passage 31A and the through-hole 21. Thus, the high-pressure water from the outside pipe will go through the inlet passage 11, the through-hole 21, the water outlet 221, and the first outlet passage 31A, and be sprayed out from the flat outlet module 32 configured on the front end of the outlet structure 30. To summarize, the second preferred embodiment of the present invention can also facilitate single-hand operation, and there is no need to temporarily block the inlet passage 11 through the trigger structure 40 as necessary in the afore-mentioned first preferred embodiment. The user can directly use the controlling component 22 to control water stop. This is indeed a practical inventive step to enable easy and quick change of the water outlet mode.

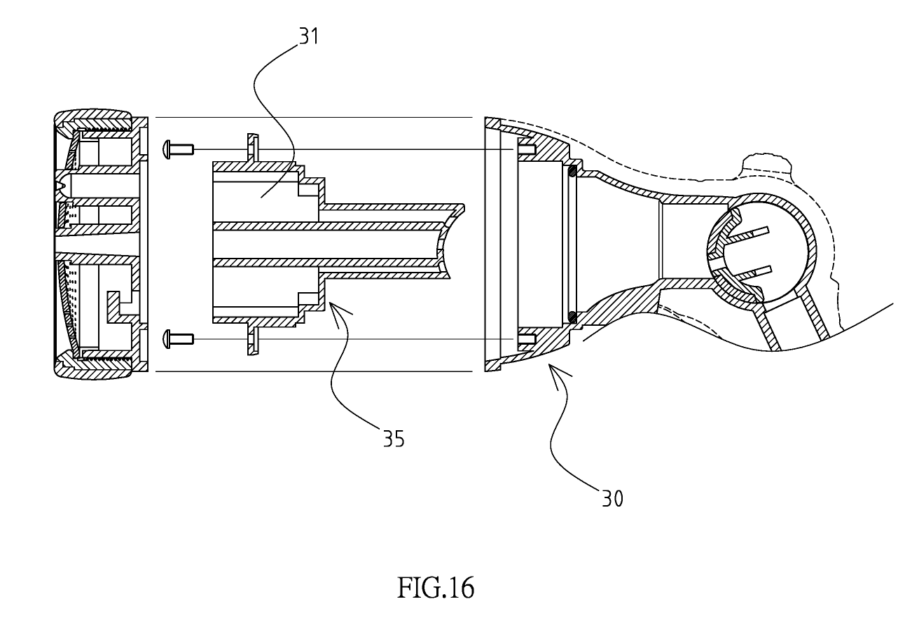

Referring to FIG. 16, a third preferred embodiment is disclosed. The main difference of this preferred embodiment from the above two preferred embodiments is the variation of the outlet structure 30. This variation can also be applied in the above first and second preferred embodiments. In this preferred embodiment, the outlet structure 30 is further installed with a base body 35, and the plurality of outlet passages 31 defined in the first and second preferred embodiments are formed in this base body 35.

### DESCRIPTION OF EFFICACY

The “water spray gun” disclosed in the present invention mainly features innovative and unique structures of a branching structure and an outlet structure, and based on inherent technical characteristics of the structures, the invention enables direct operation with the thumb of the user's hand holding the water spray gun to change the water outlet mode, without the need to temporarily stop the water spray. By enabling operation with one hand only, the invention accomplishes a practical inventive step.

I claim:

1. A water spray gun, comprising a grip with an inlet passage formed internally, a branching structure connected to the top portion of the grip, an outlet structure connected to the branching structure, and a trigger structure connected to the outlet structure and the grip. Said trigger structure selectively opens the inlet passage inside the grip, so that the water can flow serially through the branching structure and the outlet structure and then be sprayed outside, wherein:
the outlet structure is internally formed with a plurality of outlet passages, distributed serially from top to bottom, wherein, each outlet passages corresponds to a different setting of the water outlet mode of the outlet structure; and
said branching structure comprises:
a transverse through-hole, said through-hole to be interconnected to the inlet passage and the plurality of outlet passages;
a controlling component fitted inside the through-hole in a rotary mode, said controlling component being provided to seal the opposite ends of the through-hole in a liquid-tight manner, said controlling component formed with a water outlet, and said plurality of outlet passages being distributed serially along the moving path of the water outlet; and
a triggering piece connected to the controlling component, said triggering piece being provided to drive the controlling component to turn in relation to the inner wall of the through-hole, so that, when the trigger structure opens the inlet passage, the water from the inlet passage can be introduced into a corresponding outlet passages inside the outlet structure.

2. The water spray gun defined in claim 1, wherein said controlling component comprises a curved plate, and said water outlet is formed on the curved plate; the side of the curved plate facing the inner wall of the through-hole is formed with a groove surrounding the water outlet, and inside the groove, a waterproof gasket is fitted, said waterproof gasket to be attached to the inner wall of the through-hole in a liquid-tight manner.

3. The water spray gun defined in claim 2, wherein the two ends of said curved plate are respectively configured with a round disc, and the outer wall of each round disc is configured with a polygonal stopping block; said triggering piece has two sides respectively formed with a polygonal hole, wherein, each polygonal hole traps a corresponding polygonal stopping block.

4. The water spray gun defined in claim 1, wherein said outlet structure is further installed with a base body, and the plurality of outlet passages are formed in this base body.

5. The water spray gun defined in claim 2, wherein said outlet structure is further installed with a base body, and the plurality of outlet passages are formed in this base body.

6. The water spray gun defined in claim 3, wherein said outlet structure is further installed with a base body, and the plurality of outlet passages are formed in this base body.

7. The water spray gun defined in claim 4, wherein one side of said branching structure is installed with a shoring piece, said shoring piece capable of reciprocating and axial movement in relation to the branching structure; the inner side of the triggering piece corresponding to the shoring piece is formed with a plurality of stopping holes, and the number of such stopping holes is in an arrangement to correspond to that of the outlet passages; when the water outlet is interconnected to a corresponding outlet passage, the free end portion of the shoring piece is locked inside a corresponding stopping hole, so that the controlling component is temporarily positioned in relation to the branching structure.

8. The water spray gun defined in claim 5, wherein one side of said branching structure is installed with a shoring piece, said shoring piece capable of reciprocating and axial movement in relation to the branching structure; the inner side of the triggering piece corresponding to the shoring piece is formed with a plurality of stopping holes, and the number of such stopping holes is in an arrangement to correspond to that of the outlet passages; when the water outlet is interconnected to a corresponding outlet passage, the free end portion of the shoring piece is locked inside a corresponding stopping hole, so that the controlling component is temporarily positioned in relation to the branching structure.

9. The water spray gun defined in claim 6, wherein one side of said branching structure is installed with a shoring piece, said shoring piece capable of reciprocating and axial movement in relation to the branching structure; the inner side of the triggering piece corresponding to the shoring piece is formed with a plurality of stopping holes, and the number of such stopping holes is in an arrangement to correspond to that of the outlet passages; when the water outlet is interconnected to a corresponding outlet passage, the free end portion of the shoring piece is locked inside a corresponding stopping hole, so that the controlling component is temporarily positioned in relation to the branching structure.

10. A water spray gun, comprising a grip with an inlet passage formed internally, a branching structure connected to the top portion of the grip, and an outlet structure connected to the branching structure, wherein:
said outlet structure is internally formed with a plurality of outlet passages distributed serially from top the bottom, wherein each outlet passages corresponds to a different setting of the water outlet mode of the outlet structure; and
said branching structure comprises:
a transverse through-hole, said through-hole to be interconnected to the inlet passage and the plurality of outlet passages;
a controlling component fitted inside the through-hole in a rotary mode, said controlling component being provided to seal the opposite ends of the through-hole in a liquid-tight manner, said controlling component formed with a water outlet, and said plurality of outlet passages being distributed serially along the moving path of the water outlet; said controlling component selectively seals the inlet passage, and when the controlling component opens the inlet passage, the water outlet is interconnected to a corresponding outlet passage; and
a triggering piece connected to the controlling component, said triggering piece being provided to drive the controlling component to turn in relation to the inner wall of the through-hole, so that, when the controlling component opens the inlet passage, the water from the inlet passage can be introduced into a corresponding outlet passage inside the outlet structure.

11. The water spray gun defined in claim 10, wherein said controlling component comprises a curved plate, and said water outlet is formed on the curved plate; the side of the curved plate facing the inner wall of the through-hole is formed with a groove surrounding the water outlet, and inside the groove, a waterproof gasket is fitted, said waterproof gasket to be attached to the inner wall of the through-hole in a liquid-tight manner.

12. The water spray gun defined in claim 11, wherein the two ends of said curved plate are respectively configured with a round disc, and the outer wall of each round disc is configured with a polygonal stopping block; said triggering piece has two sides respectively formed with a polygonal hole, wherein, each polygonal hole traps a corresponding polygonal stopping block.

13. The water spray gun defined in claim 10, wherein said outlet structure is further installed with a base body, and a plurality of outlet passages are formed in the base body.

14. The water spray gun defined in claim 11, wherein said outlet structure is further installed with a base body, and a plurality of outlet passages are formed in the base body.

15. The water spray gun defined in claim 12, wherein said outlet structure is further installed with a base body, and a plurality of outlet passages are formed in the base body.

16. The water spray gun defined in claim 13, wherein one side of said branching structure is installed with a shoring piece, said shoring piece capable of reciprocating and axial movement in relation to the branching structure; the inner side of the triggering piece corresponding to the shoring piece is formed with a plurality of stopping holes; when the water outlet is interconnected to a corresponding outlet passage, the free end portion of the shoring piece is locked inside a corresponding stopping hole, so that the controlling component is temporarily positioned in relation to the branching structure.

17. The water spray gun defined in claim 14, wherein one side of said branching structure is installed with a shoring piece, said shoring piece capable of reciprocating and axial movement in relation to the branching structure; the inner side of the triggering piece corresponding to the shoring piece is formed with a plurality of stopping holes; when the water outlet is interconnected to a corresponding outlet passage, the free end portion of the shoring piece is locked inside a corresponding stopping hole, so that the controlling component is temporarily positioned in relation to the branching structure.

18. The water spray gun defined in claim 15, wherein one side of said branching structure is installed with a shoring piece, said shoring piece capable of reciprocating and axial movement in relation to the branching structure; the inner side of the triggering piece corresponding to the shoring piece is formed with a plurality of stopping holes; when the water outlet is interconnected to a corresponding outlet passage, the free end portion of the shoring piece is locked inside a corresponding stopping hole, so that the controlling component is temporarily positioned in relation to the branching structure.
